(19) United States
(12) Patent Application Publication
(10) Pub. No.: US 2012/0265406 A1
(43) Pub. Date: Oct. 18, 2012

(54) METHOD AND CONTROL UNIT FOR DETECTING A SAFETY-CRITICAL IMPACT OF AN OBJECT ON A VEHICLE

(76) Inventors: Gunther Lang, Stuttgart (DE); Alfons Doerr, Stuttgart (DE); Stephan Rittler, Urbach (DE)

(21) Appl. No.: 13/501,398

(22) PCT Filed: Oct. 25, 2010
(86) PCT No.: PCT/EP10/66060

§ 371 Date: Jun. 27, 2012

(30) Foreign Application Priority Data
Jan. 28, 2009 (DE) 10-2009-046067.5

(51) Int. Cl. B60R 21/013

(52) U.S. Cl. 701/45

(57) ABSTRACT

A method for detecting a safety-critical impact of an object on a vehicle is described. The method has a first step of obtaining a starting signal for starting a time measurement, to establish the start of a subsequent predetermined time span. In addition, the method has a step of receiving a signal representing a yaw acceleration of the vehicle, the signal being received during the predetermined time span. Finally, the method has a step of detecting the safety-critical impact of the object on the vehicle detecting the safety-critical impact of an object on the vehicle when the signal within the predetermined time span has a value that is outside a threshold value range or when the signal after the predetermined time span has a value derived from the signal that is outside of a threshold value range.

### FIELD OF THE INVENTION

The present invention relates to a method, a control unit, and a computer program product for detecting a safety-critical impact.

### BACKGROUND INFORMATION

The activation of restraining devices in a vehicle collision is determined in principle by the type of accident (crash type) and the severity of the accident (crash severity). Conventionally, both the type of crash and the crash severity to be expected are evaluated by the combined signal evaluation of acceleration sensors, rolling rate sensors and pressure sensors as well as forward-looking sensors (for example, radar sensors) which are integrated into the vehicle. The signal characteristics and the change in speed in both longitudinal and lateral directions are evaluated via the acceleration sensors; the continuation of a vehicle rollover movement about the longitudinal axis is evaluated via the rolling rate; two-dimensional collision contacts are detected quickly via the pressure sensors, and the collision speed and collision overlap are detected essentially via forward-looking sensors. Conventionally, both the evaluation algorithms and the sensor configuration are designed and applied on the basis of standardized crash tests.

The combined consideration of linear and rotatory changes in movement have so far played a subordinate role in crash classification of standardized crash tests, whereas in practice the combination of changes in linear and rotatory movement may frequently be observed in a crash. In the event of combined linear and rotatory accelerations, the application of force into a vehicle during a crash may have a significant influence on occupants' movements and therefore on the best possible activation of various restraining means. A crash type classification should therefore not only be oriented on the basis of changes in linear movement but should also take into account the application of force with respect to a crash-induced yaw motion and rolling motion.

PCT Application No. WO 2008/048159 A1 describes an approach for detecting a yaw motion using two lateral acceleration sensors. However, this requires an increased effort to determine the yaw performance of the vehicle.

### SUMMARY

Against this background, a method and a control unit using this method, and, finally, a corresponding computer program product are provided. Advantageous embodiments are derived from the description.

The present invention provides an example method for detecting a safety-critical impact of an object on a vehicle, the example method having the following steps:
obtaining a starting signal for starting a time measurement to establish the start of a subsequent predetermined time span;
receiving a signal representing a yaw acceleration of the vehicle, the signal being received during the predetermined time span; and
detecting the safety-critical impact of an object on the vehicle when the signal within the predetermined time span has a value that is outside a threshold value range or when the signal after the predetermined time span has a value derived from the signal that is outside of a threshold value range.

Furthermore, the present invention provides an example control unit which is designed to perform and implement the steps of the example method according to the present invention. One object on which the present invention is based may also be achieved rapidly and efficiently through this embodiment variant of the present invention in the form of a control unit.

A control unit in the present case may be understood to be an electrical device, which processes sensor signals and outputs control signals as a function thereof. The control unit may have an interface, which may be designed as hardware and/or software. In the case of a hardware embodiment, the interfaces may be part of a so-called system ASIC, for example, which includes a variety of functions of the control unit. However, it is also possible for the interface to be separate integrated circuits or to be made up of discrete components, at least in part. In the case of a software embodiment, the interfaces may be software modules, which are present on a microcontroller, for example, in addition to other software modules.

A computer program product having program code, which is stored on a machine-readable carrier such as a semiconductor memory, a hard disk or an optical disk and is used to perform the method according to one of the specific embodiments described above when the program is executed on a control unit, is also advantageous.

In accordance with the present invention, after an impact of an object on the vehicle, the vehicle usually experiences a yaw motion. This yaw motion is stronger or weaker, depending on the intensity of the impact on the vehicle. The evaluation of the yaw acceleration may be considered to be relevant in particular because this acceleration is very suitable for modeling the effects of forces on the vehicle. If a strong force is acting on the vehicle, it is to be assumed that this force was triggered by a safety-critical impact of an object on the vehicle, so that it may be necessary to implement a measure to protect an occupant in the vehicle. In this case, a yaw acceleration may be measured, which then has a value higher than a predefined threshold value or outside of a threshold value range. Occurrence of a safety-critical impact of an object on the vehicle may also be inferred if a value derived from the value of the yaw acceleration is greater than a predetermined threshold value. Such a value, which is derived from the yaw acceleration value, may be, for example, a value obtained by integration of the yaw acceleration value over time or a derivation of the yaw acceleration value according to time (in other words, in the form of a jerk).

However, it should also be noted that the evaluation should be performed within or after a predetermined time span. For this purpose, a starting signal may initially be obtained to establish a start of the predetermined time span. Such a starting signal may be supplied, for example, by one or more additional sensors of an accident sensor system (for example, a forward-looking radar sensor, an ultrasonic sensor, an acceleration sensor, a structure-borne sound sensor or the like). Such a procedure gains practical relevance in particular due to the fact that yawing of a vehicle due to an accident occurs only after the actual impact of an object on the vehicle. This makes it possible for the evaluation of the yaw acceleration to be performed only in situations in which such an impact has actually occurred or will soon occur. However, continuous monitoring of the yaw acceleration at all times while the vehicle is in motion would require an unnecessary increase in the computation power of the processor.

The example approach presented here thus offers the advantage that an impact of an object on the vehicle, which is critical for the safety of the vehicle occupants, may be detected very reliably on the basis of simple physical relationships, this detection requiring only a small measure of additional effort. This allows the use of inexpensive components, thereby advantageously reducing the manufacturing costs of a safety system for vehicle occupants.

It is advantageous in particular if the starting signal is obtained by an accident sensor system during the step of obtaining the signal, the starting signal representing a point in time of an impact of an object on the vehicle. Such a specific embodiment of the present invention permits the use of sensors of an accident sensor system, which are often already installed as standard, to supply the starting signal for the start of the aforementioned predefined time span. Very reliable detection of a safety-critical impact of an object on the vehicle may be implemented in this way.

A predefined time span having a length of 10 to 42 milliseconds may be used during the step of receiving and detecting. Such a specific embodiment of the present invention offers the advantage that the main force exerted on the vehicle by the impact acts on the vehicle in such a long time span. This means that the main yaw dynamics also play out in the stated time span, so that the evaluation of the yaw acceleration or a value derived therefrom within this time span of 10 to 42 milliseconds is a wide enough period of time to allow an inference as to the existence of a safety-critical impact.

In another specific embodiment of the present invention, during the step of detection, the value, in particular the absolute value, of the signal may be integrated over time to obtain the value derived from the signal. Such a specific embodiment of the present invention offers the advantage that a single value is not decisive for classifying an impact but instead the received signal values over a longer period of time, in particular over the entire predetermined time span, are relevant for classifying the impact. This permits an evaluation of the yaw dynamics over a longer period of time, so that a strong influence of possible measurement errors may be avoided.

During the step of detection, a threshold value which is variable over time as a characteristic line may also be used. Such a specific embodiment of the present invention offers the advantage that vehicle-specific constructions may be taken into account. For example, if areas of differing stiffness are installed in the front area of the vehicle, then the deformation of a first one of these two areas may cause a different yaw performance of the vehicle than a deformation of a second of these two areas. This then also permits optimized evaluation of the yaw performance over time, in particular the yaw acceleration, so that with the knowledge of the deformation stiffness of the two areas, an inference as to the severity of the impact is possible in a simple way by using different threshold values at different points in time within the predefined time span.

Furthermore, it is also possible that during the step of obtaining a signal, a counter is started at the point in time of a received starting signal, this counter then counting up to a maximum value during the predetermined time span, so that the predetermined time span is established. Such a specific embodiment of the present invention also permits implementation of the time measurement for the predetermined time span in a simple manner. Due to the processor-dependent specification of the maximum value, the time span to be measured may be adapted easily to the varying computation power of the processors possibly to be used.

It is favorable in particular if a step of activation of a passenger protection device is also provided when a safety-critical impact of an object on the vehicle is detected during the step of detection. Such a specific embodiment of the present invention offers the advantage that a passenger protection device is also activated to protect occupants of the vehicle, depending on the detection of a safety-critical impact of an object on the vehicle. This further increases the personal safety of vehicle occupants through measures that are technically simple to implement.

The present invention is explained in greater detail as examples on the basis of the figures.

### BRIEF DESCRIPTION OF THE DRAWINGS

FIG. 1 shows a block diagram of components for executing a first exemplary embodiment of the present invention.

FIGS. 2A-C show diagrams of different signal curves for evaluating the accident severity.

FIG. 3 shows a flow chart of another exemplary embodiment as a method.

### DETAILED DESCRIPTION OF EXAMPLE EMBODIMENTS

The same or similar elements may be provided with the same or similar reference numerals in the figures, so it is not necessary to repeat the description. Furthermore, the figures and their description contain numerous features in combination. These features may also be considered individually or combined into other combinations, which are not described here explicitly. Furthermore, the present invention is explained below using different dimensions and measures, but the present invention is not to be understood as being limited to these measures and dimensions. Furthermore, example method steps according to the present invention may also be repeated and may be executed in a different order than the order described here. If an exemplary embodiment includes an “and/or” linkage between a first feature and a second feature, this may be read as meaning that the exemplary embodiment according to one specific embodiment includes both the first feature and the second feature and according to another specific embodiment includes either only the first feature or only the second feature.

The present invention permits a classification of a crash situation, taking into account rotatory and linear movement changes in the crash of “no fire” crashes (i.e., non-safety-critical accidents which need not result in deployment of safety devices) and “must fire” crashes (e.g., AZT and ODB), i.e., safety-critical accidents, which should result in deployment of passenger safety devices in or around the vehicle.

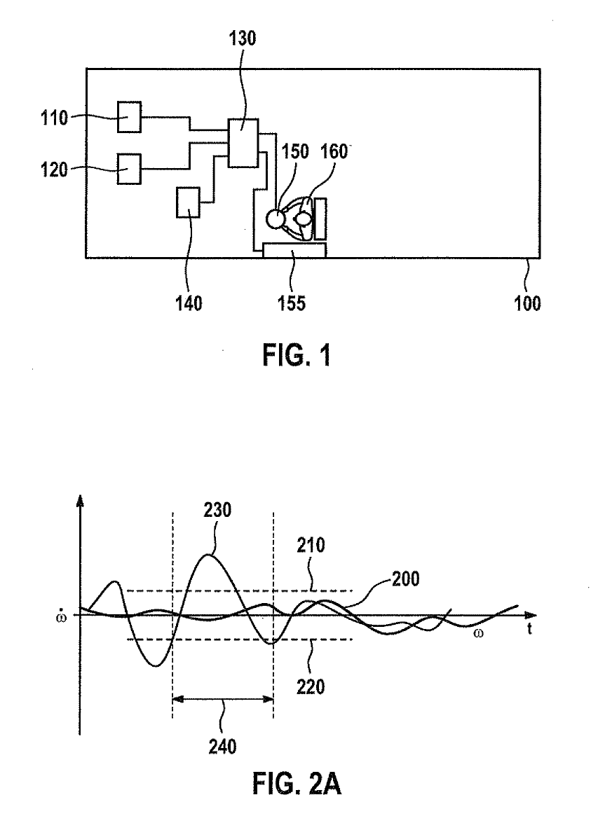

FIG. 1 shows an arrangement of components which may be used to implement a first exemplary embodiment of the present invention. FIG. 1 shows a vehicle 100 in which a first and/or a second sensor 110 and 120 is/are installed, both being connected to a central evaluation unit 130. Sensors 110 and 120 may be, for example, acceleration sensors or ultrasonic sensors installed in a front area of vehicle 100. However, it is also possible that sensors 110 and 120 are designed to measure different physical variables and transmit them to central evaluation unit 130. First sensor 110 should preferably be able to measure a different physical variable than second sensor 120.

Furthermore, a yaw sensor 140 is provided, designed to detect at least one physical variable with respect to yawing of vehicle 100 and to transmit the variable thus detected as a signal to evaluation unit 130. This physical variable may be, for example, a yaw angle, a yaw rate or a yaw acceleration. The yaw acceleration may be determined from the yaw angle or the yaw rate in evaluation unit 130, for example, by derivation over time, and then may be used for another first exemplary embodiment of the present invention.

In addition, the start of a time measurement which runs for a predetermined period of time of 10 to 100 milliseconds, for example, may also be initiated in evaluation unit 130 in response to a signal of first sensor 110 and/or second sensor 120. A signal of yaw sensor 140 may be evaluated in this predetermined period of time, hereinafter also referred to as a time span.

The evaluation in evaluation unit 130 may be performed, for example, in such a way that the fact that a signal value exceeding a threshold value is recorded within the time span, the evaluated signal value representing the yaw acceleration of vehicle 100. In such a case, it is recognized that the force of impact of the object on vehicle 100 is so great that it results in a (very) great rotation of vehicle 100 about its vertical axis (yawing). It may be concluded from this that the impact of the object on vehicle 100 is a safety-critical impact, which might entail a high risk of injury for vehicle occupants. If such a safety-critical impact of the object on vehicle 100 is recorded by evaluation unit 130, a front airbag 150 or a side airbag 155 for a driver 160 of vehicle 100, for example, may then be activated.

However, a non-safety-critical impact of an object on vehicle 100 may be inferred if no signal is obtained (or determined) from yaw sensor 140 in response to a signal of first sensor 110 or a signal of second sensor 120 in evaluation unit 130, which corresponds to a yaw acceleration greater than the threshold value. Front airbag 150 or side airbag 155 also need not be activated in this case.

Individual safety device 150 or 155 may also be activated accordingly in response to yaw accelerations obtained in different intensities or determined in evaluation unit 130. For example, when a first (minor) yaw acceleration occurs, side airbag 155 may be activated and/or when a second (stronger) yaw acceleration occurs, front airbag 150 may be activated additionally or alternatively. This permits graduated deployment of the available safety devices, depending on the severity of the accident, the severity of the accident being characterized by different yaw accelerations. However, previous algorithm approaches have been based on the separate evaluation of the rotatory and linear acceleration data used to detect discrete crash scenarios. The core of the example embodiment of the present invention may thus be seen as providing a determination of a universal feature for complex crash characteristics which include changes in both linear and rotatory movement. Using the approach presented here, it is possible to separate a “no fire” situation from a “fire” situation in the overall content of a crash scenario.

In the course of a front crash, for example, first the so-called crash box is crushed. This crash box may have, for example, sensors 110 and/or 120 shown in FIG. 1. The crash box has a fixedly defined deformation behavior, so that during crushing of the crash box, a defined force is also transferred to the vehicle, which may cause a yaw motion. Next, in a severe crash (i.e., in a crash in which a “must fire” decision is to be output for activation of safety means), the engine is impacted by the crash box. In a “no fire” crash (i.e., in a crash in which no decision need/may be output regarding deployment or activation of the safety means), the crash box is usually not crushed (completely) but is just slightly deformed. This behavior may be extracted in the signal characteristic of the yaw acceleration, which is calculated from the yaw rate according to equation 1, which follows.

$$\dot{ω} = \frac{d ω}{d t} \qquad Equation 1$$

In a crash in which a “must fire” decision is to be made, a significant, i.e., a very high signal amplitude of the yaw acceleration above a yaw acceleration threshold value is to be expected. This results from the fact that such a case results in engagement (impact) of the crash box with the engine (block). In this case, the collision of the deformable crash box with the hard engine block causes a definite vibration, which is detectable as a high yaw acceleration by the yaw sensor or in evaluation unit 130. In a crash in which a “no fire” decision is to be made, i.e., in which a decision is to be made that a safety device such as front airbag 150 or side airbag 155 is not activated, this high signal amplitude is reached only at a late point in the crash characteristic. This crash characteristic may then be detected very easily by evaluating the yaw acceleration which occurs within the aforementioned time window, and it may be processed further. The example embodiment of the present invention thus permits a clear-cut decision as to whether a safety-critical impact of an object on the vehicle has occurred, even if the yaw acceleration is above the threshold value outside of the predetermined time span.

To now permit a reliable evaluation, the evaluation range of the signal may be limited, as already described above. This means that as soon as a yaw acceleration monitoring module in evaluation unit 130 has been activated (for example, by receiving the starting signal from additional sensors of the accident sensor system), a counter, for example, begins to run. The counter has a maximum value, which is reached on expiration of the predetermined time span. Therefore, by specifying the maximum value, the predefined time span may be technically set in a very simple manner as a function of the processor speed. If a predetermined threshold value is now exceeded, there is no crash in which a “no fire” decision should be output as long as the counter has not reached its maximum value (i.e., as long as the predetermined time span has not elapsed).

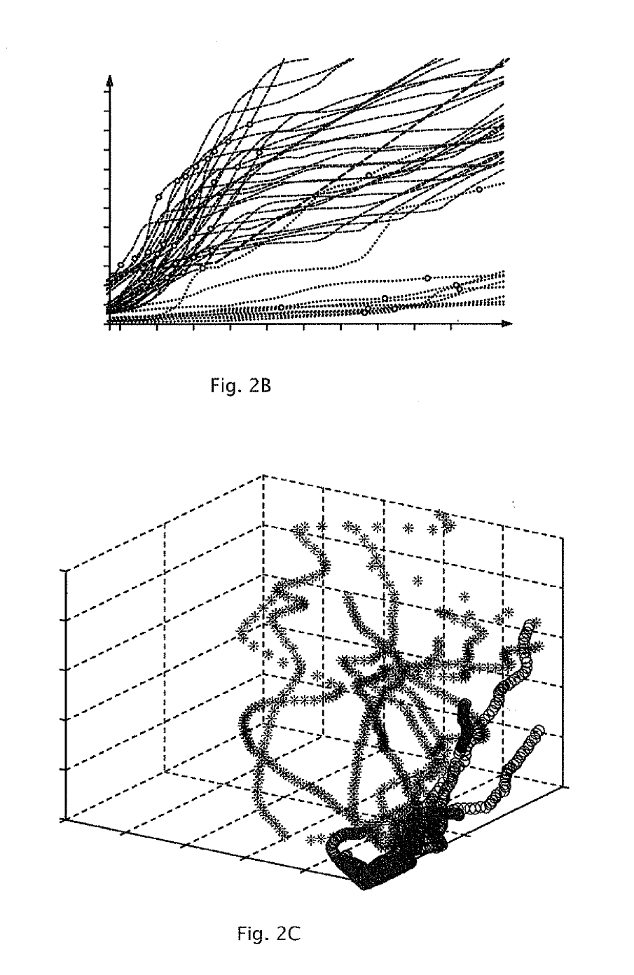

FIG. 2A shows a signal characteristic of the received yaw acceleration as a function of time for different accidents. In the first accident, which does not model a safety-critical impact of an object on the vehicle (black solid line 200 for the yaw acceleration to be expected), the yaw acceleration varies only within a (threshold) value range, so that it does not exceed a positive threshold value 210 and does not fall below a negative threshold value 220. In such a scenario, the accident having occurred may be evaluated as a non-safety-critical impact of an object on the vehicle, so that activation of corresponding safety device is not necessary.

However, if a yaw acceleration value is received in evaluation unit 130, as represented by gray solid line 230, for example, an accident involving a safety-critical impact of an object on the vehicle may be inferred. Threshold value 210 is exceeded within time span 240 in this case, so that the criterion for classifying the accident as a safety-critical impact is met. However, it should be noted here that threshold value 210 is exceeded only after the start of the time measurement, which is started by a signal from one or more additional accident sensors, so that exceeding a yaw acceleration value outside of time span 240 does not necessarily cause the accident to be classified as a safety-critical impact of an object on the vehicle. The robustness of deployment of safety devices for vehicle occupants is definitely increased in this way.

An accident may be classified as a safety-critical impact of an object on the vehicle by further alternative processing of signals of yaw sensor 140. For example, a value representing yaw dynamics is formed from the signal of yaw sensor 140 according to equation 2.

Yaw dynamics equal=∫|\tilde{ω}| Equation 2

The calculated “yaw dynamics” value from equation 2 may be evaluated, for example, via a counter (timer) (i.e., via dt) or via any dv (Dvy, Dvx, etc.). If a threshold value is exceeded here (for example, in the form of a characteristic line, which is variable in the time span), then there is no crash, which should cause a “no fire” decision.

In FIG. 2B an exemplary embodiment for evaluation of the yaw dynamics shows a plot of the integral of the acceleration in the x direction. By using a dividing line (shown as a solid line in FIG. 2B) to separate ODB crashes (represented as a dashed line in FIG. 2B) from “no fire” crashes (represented as a dotted line in FIG. 2B), reliable detection of a threshold value at which safety devices are deployed or activated is made possible. The situations having yaw rate values below the black dividing line thus do not result in deployment of the safety devices.

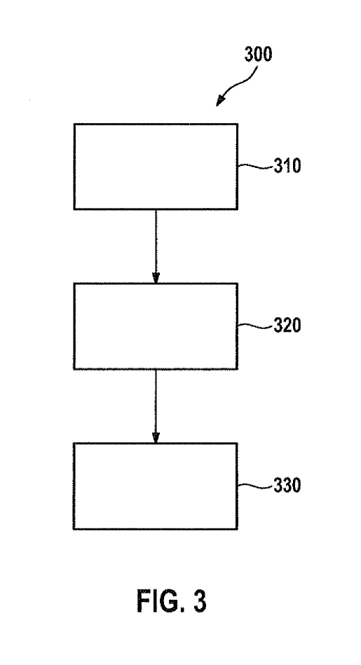

Another exemplary embodiment of the present invention is described using the diagram from FIG. 2C, the signal evaluation in 3-D space being used here. The values for ∫Acc-X=Dv and ∫Acc-Y=DvY as well as the corresponding yaw rate values (on the z axis) are plotted on both axes. The yaw rate values are shown as a cross In FIG. 2C, representing a “fire crash,” i.e., reflecting a scenario in which a safety device should be deployed. However, FIG. 2C shows the yaw rate values as a circle representing “no fire crashes,” i.e., scenarios in which the safety means should not be deployed. It is thus apparent from FIG. 2C that an engine characteristics map (three-dimensional) is inserted now for discriminating between deployment scenarios and non-deployment scenarios. FIG. 3 shows a flow chart of an exemplary embodiment of the present invention as method 300 for detecting a safety-critical impact of an object on a vehicle. Method 300 includes a step of obtaining 310 a starting signal for starting a time measurement to establish the start of a subsequent predetermined time span. Furthermore, method 300 has a step of receiving 320, a signal representing a yaw acceleration of the vehicle, the signal being received during the predetermined time span. Finally, method 300 includes a step of detection 330 of the safety-critical impact of the object on the vehicle detecting the safety-critical impact of an object on the vehicle when the signal within the predetermined time span has a value that is outside a threshold value range or when the signal after the predetermined time span has a value derived from the signal that is outside of a threshold value range.

1-9. (canceled)

10. A method for detecting a safety-critical impact of an object on a vehicle, comprising:
obtaining a starting signal for starting a time measurement to establish a start of a subsequent predetermined time span;
receiving a signal representing a yaw acceleration of the vehicle, the signal representing the yaw acceleration being received during the predetermined time span; and
detecting the safety-critical impact of an object on the vehicle when the signal received during the predetermined time span has a value that is outside a threshold value range or when a signal derived from the signal received during the predetermined time span that has a value is outside of a threshold value range.

11. The method as recited in claim 10, wherein during the step of obtaining the starting signal, the starting signal represents a point in time of an impact of an object on the vehicle.

12. The method as recited in claim 10, wherein during the step of receiving, the signal representing the yaw acceleration and of detecting, the predefined time span has a length between 10 and 100 milliseconds.

13. The method as recited in claim 10, wherein during the step of detecting the value, an absolute value of the signal representing the yaw acceleration is integrated over time to obtain the value derived from the signal.

14. The method as recited in claim 10, wherein during the step of detecting, a threshold value is used to determine the threshold value range which is variable over time as a characteristic line.

15. The method as recited in claim 10, wherein during the step of obtaining a signal, a counter is started at a point in time of a received starting signal, the counter counting up to a maximum value during the predetermined time span, so that the predetermined time span is established.

16. The method as recited in claim 10, further comprising:
activating a passenger protection device when the safety-critical impact of an object on the vehicle is detected during the detecting step.

17. A control unit for detecting a safety-control impact of an object on a vehicle, the control unit configured to obtain a starting signal for starting a time measurement to establish a start of a subsequent predetermined time span, to receive a signal representing a yaw acceleration of the vehicle, the signal representing the yaw acceleration being received during the predetermined time span, and to detect the safety-critical impact of an object on the vehicle when the signal received during the predetermined time span has a value that is outside a threshold value range or when a signal derived from the signal received during the predetermined time span that has a value is outside of a threshold value range.

18. A computer readable storage medium storing the program code for detecting a safety-control impact of an object on a vehicle, the program code, when executed by a control unit, causing the control unit to perform the steps of:
obtaining a starting signal for starting a time measurement to establish a start of a subsequent predetermined time span;
receiving a signal representing a yaw acceleration of the vehicle, the signal representing the yaw acceleration being received during the predetermined time span; and
detecting the safety-critical impact of an object on the vehicle when the signal received during the predetermined time span has a value that is outside a threshold value range or when a signal derived from the signal received during the predetermined time span that has a value is outside of a threshold value range.
